(19) United States
(12) Patent Application Publication
(10) Pub. No.: US 2011/0200072 A1
(43) Pub. Date: Aug. 18, 2011

(54) METHOD AND APPARATUS FOR SELECTING A CHANNEL IN WIDEBAND HIGH FREQUENCY WIRELESS SYSTEM

(75) Inventors: Seung Eun Hong, Daejeon (KR); Hyoung Jin Kwon, Daejeon (KR); Kyeong Pyo Kim, Daejeon (KR); Yong Sun Kim, Daejeon (KR); Woo Yong Lee, Daejeon (KR)

(73) Assignee: ELECTRONICS AND TELECOMMUNICATIONS RESEARCH INSTITUTE, Daejeon (KR)

(21) Appl. No.: 13/119,620

(22) PCT Filed: Sep. 17, 2009
(86) PCT No.: PCT/KR2009/005311

§ 371 Date: Mar. 17, 2011

(30) Foreign Application Priority Data
Sep. 19, 2008 (KR) 1020080092127
Sep. 25, 2008 (KR) 1020080094270
Mar. 16, 2009 (KR) 1020090022224

(51) Int. Cl. H04B 1/00

(52) U.S. Cl. 375/130; 375/E01.001

(57) ABSTRACT

Provided is a method and apparatus for selecting a channel in a wideband high frequency wireless system. The channel selection method may include: generating a channel scanning request frame that includes a channel bitmap, wherein the channel bitmap denotes information regarding a channel to be scanned by a neighboring device; transmitting the channel scanning request frame to the neighboring device; receiving a channel scanning response frame corresponding to the channel scanning request frame; and selecting a channel for a communication with the neighboring device, based on the channel scanning response frame.

### TECHNICAL FIELD

The present invention relates to a wireless communication system where a high speed transmission is enabled using an ultra-wideband high frequency signal having a strong straightness, and more particularly, to a method of setting a channel and a detour path in a wideband high frequency wireless system using a distributed Media Access Control (MAC) protocol, and an apparatus for performing the method.

### BACKGROUND ART

In a wideband high frequency wireless system using a distributed Media Access Control (MAC) protocol, a communication apparatus may be classified into any one of three types. For example, a communication apparatus of a type A may support antenna training and a communication distance thereof is about 10 meters. A communication apparatus of a type B may not support antenna training, and a communication distance thereof is about five meters. A communication apparatus of a type C may support only a master-slave operation and a communication apparatus thereof is about 2 meters.

In the wideband high frequency wireless system using the distributed MAC protocol, when a power is applied, the communication apparatus may initially verify which neighboring devices exist in a current network. The communication apparatus may perform a discovery procedure to perform antenna training with a neighboring device, as necessary.

Hereinafter, the communication apparatus performing the discovery procedure is referred to as a discovery device.

To search for neighboring devices, the discovery device may transmit, via a discovery channel, a beacon where a status field is set to a discovery. Hereinafter, the beacon where the status field is set to the discovery is referred to as a discovery beacon.

Also, to search for different types of neighboring devices, the discovery device may transmit a beacon using a physical (PHY) mode supported by a desired type of a neighboring device.

When the neighboring devices are found, the discovery device may select a neighboring device that the discovery device desires to communicate with, and perform an antenna training procedure with the selected neighboring device. When the antenna training procedure is completed, the discovery device and the selected neighboring device may perform a process of selecting, from allocated channels, a channel suitable for a communication.

In the wideband high frequency wireless system using the distributed MAC protocol, the communication apparatus of the type A may transmit a discovery beacon block of FIG. 1 to search for a neighboring device.

Referring to FIG. 1, the discovery beacon block includes Mode-DO Discovery Beacon, and Mode-BO Poll, Mode-CO Poll. The discovery device transmitting the discovery beacon block may be waiting in a C-SCAN interval, a B-SCAN interval, and a Mode DO-SCAN interval to receive a response from neighboring devices of the type A, the type B, and the type C. When the discovery device includes a plurality of antennas, the above discovery beacon block transmission and response reception process may be repeated the same number of times as the number of antennas. The discovery device may become aware that corresponding neighboring devices exist by receiving the response in the above scan intervals.

When the neighboring devices are found, the discovery device may select a desired neighboring device and perform antenna training with the selected neighboring device.

The above searching for the neighboring device and antenna training process may be performed using a discovery channel.

Since the channel selection operation is performed by scanning a unit channel, information associated with a bonding channel where unit channels are bonded may not be obtained.

Due to a frequency characteristic, only when a line of sight (LOS) is secured between a transmitter and a receiver, may a smooth communication be possible in the wideband high frequency wireless system using the distributed MAC protocol. When the LOS is not obtained due to a human being, an obstacle, and the like, a communication error such as a communication stoppage may occur. Even when the LOS is blocked for a relatively very short period of time, the communication error caused by a signal interruption may cause a serious problem in high speed data transmission and video streaming transmission.

The wideband high frequency wireless system using the distributed MAC protocol may include a relay device providing a detour path to avoid a communication error that may occur when signals are blocked due to a human being, an obstacle, and the like.

Here, the relay device may relay a source device and a destination device. The destination device may maintain antenna setting information associated with the relay device and the source device. A single destination device may include single antenna setting information. Accordingly, it may be impossible to select a channel suitable for a direct path communication and a detour path communication using the relay device.

### DISCLOSURE OF INVENTION

1. Technical Problem

An aspect of the present invention provides a channel selection method and apparatus that may perform signaling so that information associated with a unitary channel and a bonding channel may be obtained in a wideband high frequency wireless system, particularly, in a wideband high frequency wireless system using a distributed Media Access Control (MAC) protocol.

Another aspect of the present invention also provides a channel selection method and apparatus that may quickly provide a detour path without a communication error, when a signal blockage occurs while a source device and a destination device are performing a data communication via a direct path.

2. Solution to Problem

According to an aspect of the present invention, there is provided a method of selecting a channel in a wireless system, the method including: generating a channel scanning request frame that includes a channel bitmap, the channel bitmap denoting information regarding a channel to be scanned by a neighboring device; transmitting the channel scanning request frame to the neighboring device; receiving a channel scanning response frame corresponding to the channel scanning request frame; and selecting a channel for a communication with the neighboring device, based on the channel scanning response frame.

The channel bitmap may include the same number of bits as a number of channels available in a network.

The channel bitmap may correspond to each of unit channels available in the network and a bonding channel of the unit channels.

The generating may include: verifying specification information of the neighboring device; verifying available channels of the neighboring device based on the specification information; and determining the channel to be scanned by the neighboring device, among the available channels.

The channel scanning response frame may include a number of information elements corresponding to a number of channels to be scanned by the neighboring device. Each of the information elements may include information associated with an available time slot in each of the channels scanned by the neighboring device.

The channel scanning request frame may include a channel selection control field. The channel selection control field may include a command identification (ID) field to identify a type of a channel selection command frame, a reason code field to identify a reason of a channel change response result when the type of the channel selection command frame is a channel change response, and a channel bitmap field that includes the channel bitmap indicating the channel to be scanned by the neighboring device.

The selecting may include selecting the channel for the communication with the neighboring device based on scanning information associated with the channel scanned by the neighboring device and scanning information associated with a channel scanned by a communication apparatus receiving the channel scanning response frame.

### ADVANTAGEOUS EFFECTS OF INVENTION

According to embodiments of the present invention, in a wideband high frequency wireless system using a distributed Media Access Control (MAC) protocol, it is possible to scan unit channels and bonded channels. Also, it is possible to decrease a time taken to set a direct path and a detour path between a source device and a destination device.

### BRIEF DESCRIPTION OF DRAWINGS

FIG. 1 illustrates an example of a discovery beacon block according to a conventional art;

FIG. 2 illustrates an example of a channel structure allocated to a network in a wideband high frequency wireless system using a distributed Media Access Control (MAC) protocol according to an embodiment of the present invention;

FIG. 3 is a block diagram illustrating a configuration of a communication apparatus according to an embodiment of the present invention;

FIG. 4 is a flowchart illustrating a channel selection method according to an embodiment of the present invention;

FIG. 5 illustrates a format of a channel selection command frame according to an embodiment of the present invention; and

FIG. 6 is a flowchart illustrating a channel selection method when a relay device exists according to an embodiment of the present invention.

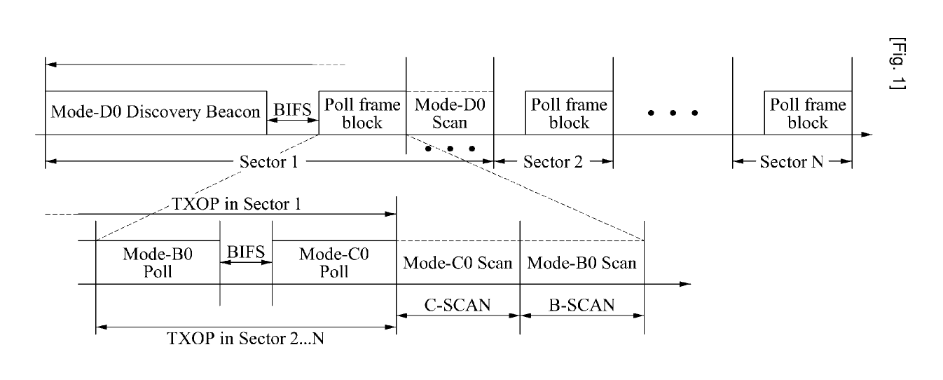

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

Hereinafter, embodiments of the present invention will be described in detail with reference to the accompanying drawings. When it is determined detailed description related to a known function or configuration they may render the purpose of the present invention unnecessarily ambiguous in describing the present invention, the detailed description will be omitted here.

The present invention may be applicable to a wideband high frequency wireless system using a distributed Media Access Control (MAC) protocol.

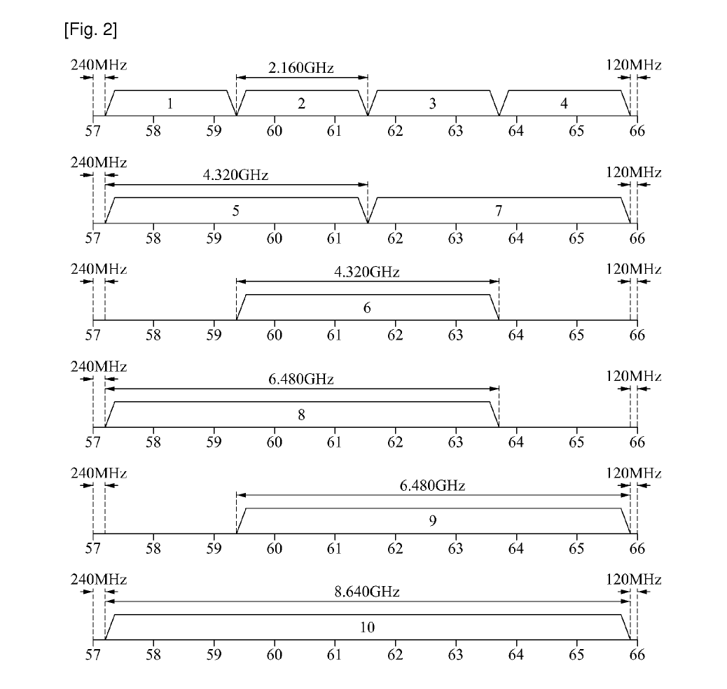

FIG. 2 illustrates an example of a channel structure allocated to a network in a wideband high frequency wireless system using a distributed MAC protocol according to an embodiment of the present invention.

Referring to FIG. 2, in the wideband high frequency wireless system using the distributed MAC protocol, channels allocated to the network may include four channels 1, 2, 3, and 4 that are unit channels, and six channels 5, 6, 7, 8, 9, and 10 that are bonding channels. Here, the unit channel 3 may be used as a discovery channel.

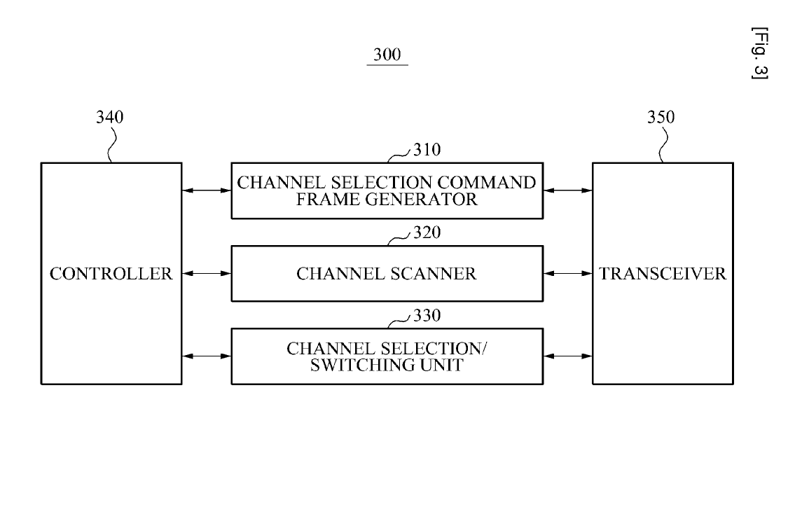

FIG. 3 is a block diagram illustrating a configuration of a communication apparatus 300 according to an embodiment of the present invention.

The configuration of the communication apparatus 300 may be applicable to a discovery device according to an embodiment of the present invention. Hereinafter, it is assumed that the communication apparatus 300 is the discovery device.

Referring to FIG. 3, the discovery device 300 may include a channel selection command frame generator 310, a channel scanner 320, a channel selection/switching unit 330, and a transceiver 350.

Also, the discovery device 300 may further include a controller 340 to control operations of the channel selection command frame generator 310, the channel scanner 320, the channel selection/switching unit 330, and the transceiver 350.

The channel selection request frame generator 310 may determine a channel to be scanned by a neighboring device among channels available in a network, and may generate a channel selection command frame indicating the channel to be scanned by the neighboring device. The channel selection command frame corresponds to a channel scanning request frame requesting channel scanning. Accordingly, the channel selection command frame generator 310 may also be referred to as a “channel scanning request frame generator”. The channel selection command frame generator 310 may determine the channel to be scanned by the neighboring device, based on a device combination of the following Table 1. The channel selection command frame generator 310 may verify specification information of the neighboring device, verify available channels of the neighboring device based on the specification information, and determine the channel to be scanned by the neighboring device, among the available channels.

The channel bitmap may include the same number of bits as a number of channels available in the network.

The channel selection command frame may be in a format of FIG. 5, which will be further described in detail later.

The channel scanner 320 may scan available channels in the network in order to select a channel for a communication with the neighboring device. In this instance, the channel scanner 320 may determine the channel to be scanned by the discovery device 300 with reference to Table 1 below. Also, the channel scanner 320 may scan a channel excluding the channel to be scanned by the neighboring device among the available channels in the network.

Here, the available channels in the network may include at least one channel among 10 channels allocated to the network as shown in FIG. 2.

Accordingly, the available channels in the network may include unit channels and bonding channels where the unit channels are bonded.

The channel selection/switching unit 330 may select, from the available channels in the network, the channel for the communication with the neighboring device, and may perform channel switching to the selected channel. Here, the channel selection/switching unit 330 may select the channel for the communication with the neighboring device based on a response message with respect to the channel scanning request frame. Also, the channel selection/switching unit 330 may select the channel for the communication with the neighboring device by considering both a scanning result of the neighboring device and a scanning result of the channel scanner 320. Accordingly, the channel selection/switching unit 330 may select the channel for the communication with the neighboring device based on scanning information associated with the channel scanned by the neighboring device and scanning information associated with the channel scanned by the channel scanner 320.

The transceiver 340 may transmit the channel selection command frame to the neighboring device, and receive, from the neighboring device, the response message with respect to the channel selection command frame. Here, the response message with respect to the channel selection command frame corresponds to a channel scanning response frame, which will be described later. Accordingly, the response message may include a number of information elements corresponding to a number of channels to be scanned by the neighboring device. Each of the information elements may include information associated with an available time slot in each of the channels scanned by the neighboring device.

A channel selection method performed by the communication apparatus of FIG. 3 may include: generating a channel scanning request frame that includes a channel bitmap, wherein the channel bitmap denotes information regarding a channel to be scanned by a neighboring device; transmitting the channel scanning request frame to the neighboring device; receiving a channel scanning response frame corresponding to the channel scanning request frame; and selecting a channel for a communication with the neighboring device, based on the channel scanning response frame.

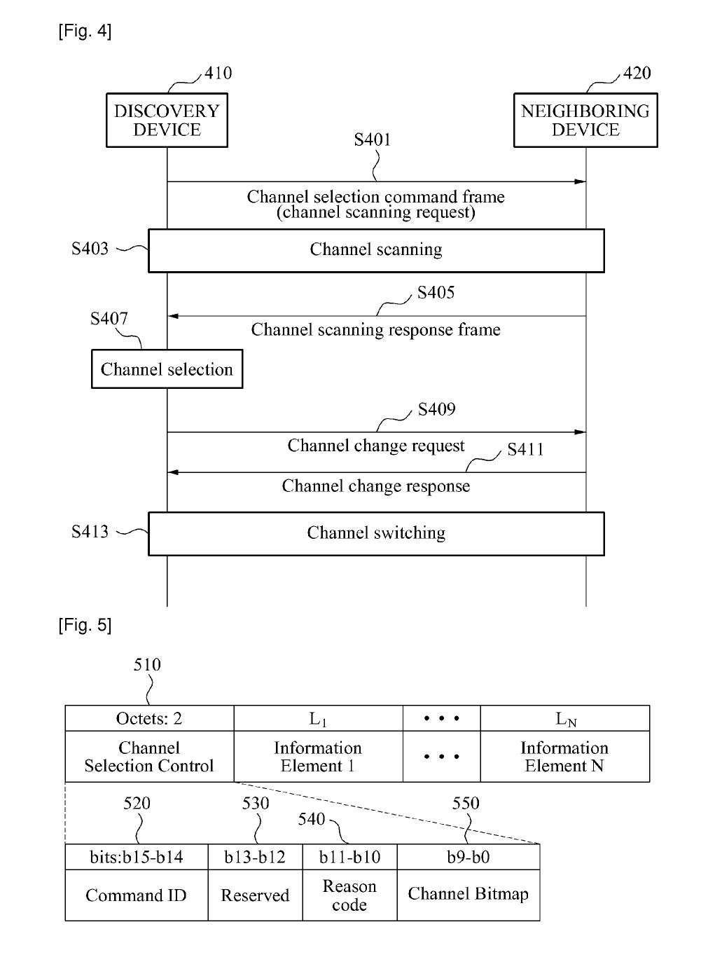

Hereinafter, the channel selection method performed by the communication apparatus will be described with reference to FIG. 4.

FIG. 4 is a flowchart illustrating a channel selection method according to an embodiment of the present invention.

When antenna training is completed, a discovery device 410 and a neighboring device 420 may perform a channel selection process. Here, the discovery device 410 may search for the neighboring device 420 within a network for a communication, and perform antenna training with the found neighboring device 420.

The antenna training process denotes a process of exchanging an antenna parameter and the like to maximize a link performance set between communication apparatuses. Generally, a communication apparatus performing antenna training may select a sector or adjust a transmit and receive beam pattern using the antenna training process.

Referring to FIG. 4, in operation S401, the discovery device 410 may transmit, to the neighboring device 420, a channel selection command for a channel scan signaling with respect to each of unit channels and bonding channels. Here, the channel selection command frame may be a channel scanning request frame transmitted for a channel scanning request.

In the present specification, the channel selection command frame transmitted for the channel scanning request is referred to as a channel scanning request frame.

Prior to transmitting the channel scanning request frame to the neighboring device 420, the discovery device 410 may determine a channel to be scanned by the neighboring device 420 among channels available in the network, and generate the channel scanning request frame that includes a channel bitmap indicating the channel to be scanned by the neighboring device 420.

Here, the discovery device 410 may verify specification information of the neighboring device 420, verify available channels of the neighboring device 420 based on the specification information of the neighboring device 420, and determine the channel to be scanned by the neighboring device 420 among the available channels. The discovery device 410 may indicate the channel to be scanned in the channel scanning request frame using the channel bitmap.

While searching for neighboring devices in the network, the discovery device 410 may be aware of the specification information of the neighboring device 420 by transmitting and receiving a beacon message.

Specifically, prior to performing the channel selection process, the discovery device 410 may transmit, to the neighboring device 420, the beacon message to verify the specification information of the neighboring device 420, receive a response message corresponding to the beacon message, and verify the specification information of the neighboring device 420 according to the response message.

The discovery device 410 may verify whether each communication apparatus may use a bonding channel such as the channels 5, 6, 7, 8, 9, and 10 among the channels as shown in FIG. 2.

The discovery device 410 may determine the channel to be scanned by the discovery device 410 and the channel to be scanned by the neighboring device 420, based on specification information regarding the discovery device 410 and the neighboring device 420.

The following Table 1 shows an example of device combinations based on the specification information regarding the discovery device 410 and the neighboring device 420. An operation of channel scan signaling according to each device combination will be described later.

TABLE 1

| | Spec of destination device | |
|---|---|---|
| | Channel bonding | Channel bonding |
| Spec of source device | possible | impossible |
| Channel bonding | Device combination 1 | Device combination 2 |
| possible | | |
| Channel bonding | Device combination 3 | Device combination 4 |
| impossible | | |

In operation S403, the discovery device 410 and the neighboring device 420 may perform channel scanning. The discovery device 410 and the neighboring device 420 may be aware of timing information to start or terminate channel scanning by exchanging the channel scanning request frame.

The neighboring device 420 may interpret the channel selection command frame transmitted from the discovery device 410 to verify the channel to be scanned by the neighboring device 420.

In operation S405, the discovery device 410 may receive a channel scanning response frame from the neighboring device 420.

The channel scanning response frame may include scanning information associated with channels scanned by the neighboring device 420. The scanning information may include information regarding a time slot that may be used as a communication resource in a corresponding channel, whether a corresponding channel is suitable for a communication, whether inter-channel interference exists, and the like.

In operation S407, the discovery device 410 may select a channel for a communication with the neighboring device 420 based on the channel scanning response frame. Here, the discovery device 410 may select the channel for the communication with the neighboring device 420 by considering both scanning information associated with channels scanned by the discovery device 410 and scanning information associated with channels scanned by the neighboring device 420. Here, a channel selection criterion may be determined based on various types of communication standards and channel statuses.

In operation S409, the discovery device 410 may inform the neighboring device 420 about the selected channel, using a channel change request message.

In operation S411, the neighboring device 420 may inform the discovery device 410 about that the channel change request message is received, using a channel change response message.

In operation S413, the discovery device 410 and the neighboring device 420 may perform channel switching to the selected channel.

FIG. 5 illustrates a format of a channel selection command frame according to an embodiment of the present invention.

Referring to FIG. 5, the channel selection command frame may include a channel selection control field 510 and N information element fields. Here, N denotes a natural number.

Each of the information element fields may include various types of information elements associated with a channel selection. For example, the information element field may include a scan timing information element regarding when each communication apparatus may perform scanning and when a corresponding communication apparatus may return to a discovery channel to perform a scanning response, and the like. Also, the information element field may include a scanning information element of a channel scanned by the communication apparatus. Also, the information element field may include an information element indicating which channel is selected from channels allocated to the network.

The channel selection control field 510 may include control information for the channel selection, and may include 2 octets.

The channel selection control field 510 may include a 2-bit command identification (ID) field 520, a 2-bit reserved field 530, a 2-bit reason code field 540, and a 10-bit channel bitmap field 550.

The command ID field 520 may identify a type of the channel selection command frame and thus may be used to classify the type of the channel selection command frame into a “channel scanning request”, a “channel scanning response”, a “channel change request”, or a “channel change response”.

Here, the channel selection command frame may be represented as a “channel scanning request frame”, a “channel scanning response frame”, a “channel change request command frame”, and a “channel change response command frame”.

The reserved field 530 denotes a field reserved for information to be additionally added in association with a channel selection control.

The reason code field 540 may be used as a reserved field or as a field to express a response to a channel change depending on a usage of the channel selection command frame. For example, when the channel selection command frame is used for the channel scanning request and the channel scanning response, the reason code field 540 may be used as the reserved field. When the channel selection command frame is used for the change response, the reason code field 540 may be used to identify an agreement to the channel change, a denial reason for the channel change, and the like.

The channel bitmap field 550 may include the channel bitmap indicating a channel to be scanned by a neighboring device.

The channel bitmap may include the same number of bits as a number of channels available in the network. Also, the channel bitmap may include four bits corresponding to four unit channels available in the network and six bits corresponding to six bonding channels available in the network.

When each bit of the channel bitmap is zero, it may indicate that there is no need to scan a corresponding channel. When each bit is “1”, it may indicate that there is a need to scan the corresponding channel. Hereinafter, it is assumed that, when each bit of the channel bitmap field 550 is “1”, the corresponding channel may need to be scanned.

An encoding example of the channel bitmap field 550 may be given by the following Table 2

TABLE 2

| Bit | Band ID | Description |
|---|---|---|
| 0 | 1 | Channel 1 |
| 1 | 2 | Channel 2 |
| 2 | 3 | Channel 3 |
| 3 | 4 | Channel 4 |
| 4 | 5 | Channel 5 |
| 5 | 6 | Channel 6 |
| 6 | 7 | Channel 7 |
| 7 | 8 | Channel 8 |
| 8 | 9 | Channel 9 |
| 9 | 10 | Channel 10 |

A discovery device and a neighboring device exchanging the channel selection command frame may become aware of mutual specification information by transmitting and receiving a beacon message. Here, it is assumed that the discovery device corresponds to a source device transmitting data, and the neighboring device corresponds to a destination device receiving the data.

Referring to the above Table 1, in the case of the device combination 1, both the source device and the destination device may support channel bonding. Accordingly, the source device may make an indication in the channel bitmap field 550 so that the destination device may scan all the available channels, and may transmit the channel selection command frame including the channel bitmap field 550. Through this, the destination device may select the most suitable channel for a data communication. In the case of the channels 1 and 5, or the channels 2 and 5 where frequency bands overlap, inter-channel interference may occur, which may result in causing a communication error. In particular, when scanning a bonding channel, the source device may need to make the destination device scan unit channels where frequency bands overlap among the channels 1, 2, 3, and 4.

Referring to the above Table 1, in the case of the device combination 2, the destination device may not perform channel bonding, that is, may not scan the channels 5, 6, 7, 8, 9, and 10 that are the bonding channels. Accordingly, in the case of the device combination 2, the source device may constitute the channel bitmap field 550 so that the destination device may scan the unit channels among the channels 1, 2, 3, and 4. Here, the source device may scan the bonding channels and thus scan the channels 5, 6, 7, 8, 9, and 10. The source device may need to select a most excellent channel from the channels 1, 2, 3, and 4 to communicate with the destination device, based on scanning information of the source device and scanning information of the destination device.

Referring to the above Table 1, in the case of the device combination 3, the source device may not support channel bonding, which may correspond to a case where the source device may not scan the channels 5, 6, 7, 8, 9, and 10 that are the bonding channels. However, to select a channel suitable for a communication, information associated with the channels 5, 6, 7, 8, 9, and 10 may be required. Accordingly, in the case of the device combination 3, the source device may constitute the channel bitmap field 550 so that the destination device may scan the channels 5, 6, 7, 8, 9, and 10. To reduce a channel scanning time, the source device may constitute the channel bitmap field 550 so that the source device may scan only the channels 1, 2, 3, and 4, and the destination device may scan only the channels 5, 6, 7, 8, 9, and 10. Here, the most excellent channel may be selected, as the channel suitable for the data communication, from the channels 1, 2, 3, and 4 based on the scanning information of the source device and the scanning information of the destination device.

Referring to the above Table 1, in the case of the device combination 4, neither the source device nor the destination device may support channel bonding, which may correspond to a case where neither the source device nor the destination device may scan the channels 5, 6, 7, 8, 9, and 10. In this case, the source device may constitute the channel bitmap field 550 so that the destination device may scan at least one channel among the channels 1, 2, 3, and 4. Here, the source device may also scan only the channels 1, 2, 3, and 4.

Here, channel interference caused by overlapping of frequency bands may be minimized by not bonding one fixed channel among the channels 1, 2, 3, and 4 when constituting a bonding channel. Specifically, in the device combination 4, only the channel 1 may be used in such a manner that a network manager sets the channel 1 to not be bonded.

As described above, in the channel selection according to an embodiment of the present invention, the discovery device may transmit the channel scanning request frame to the neighboring device so that channels suitable for the communication may be scanned. The discovery device may perform signaling for channels to be scanned using the channel bitmap field 550.

The neighboring device may scan the designated channels and determine whether the scanned channels are suitable for the communication. The neighboring device may return to a discovery channel and inform the discovery device about a search result using a channel scanning response frame.

When informing the discovery device about the search result, the neighboring device may include, in the channel bitmap field 550, a number of channel search results corresponding to a number of bits set to “1”. Here, each channel search result may need to use a single information element and thus the channel scan response frame may include a number of information elements corresponding to the number of bits set to “1”.

The information elements including the channel search results of the channel scanning response frame may be sorted in the channel bitmap field 550 in an order of bits set to 1. When a corresponding channel includes a periodical time frame and the time frame includes a plurality of time slots, an information element including the channel search result may include information associated with time slots available in the corresponding channel, that is, time slots unused by other devices.

The discovery device receiving the channel search result from the neighboring device may select a most suitable communication channel, and may inform the neighboring device about information associated with the selected communication channel using the channel change request command frame. The neighboring device may make a response using the channel change response command frame. The discovery device and the neighboring device may switch to the selected channel and perform transmitting and receiving of data.

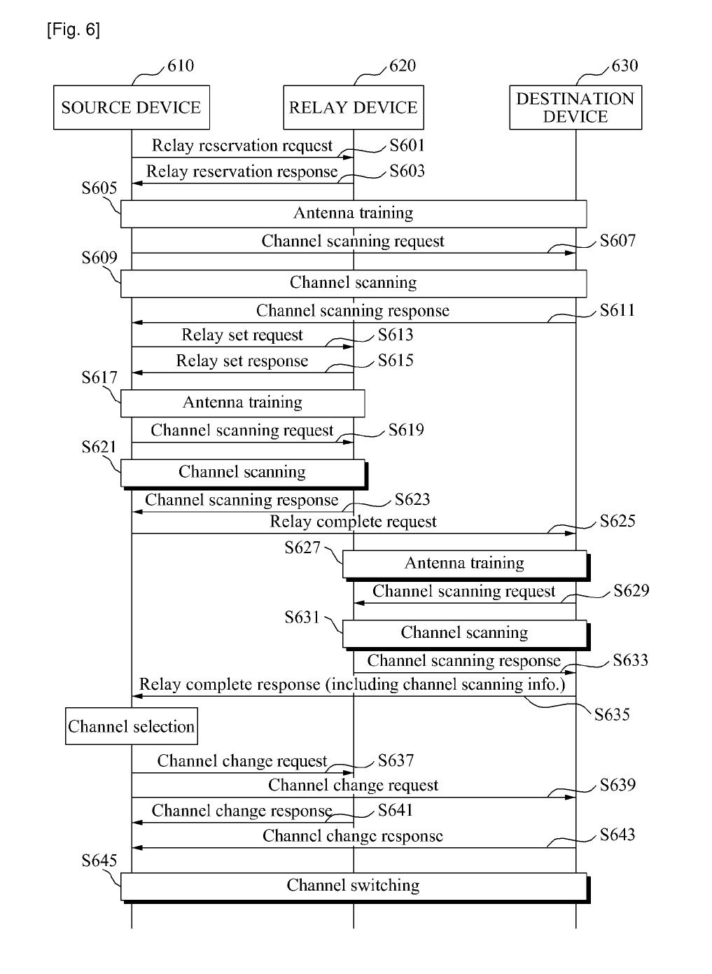

FIG. 6 is a flowchart illustrating a channel selection method when a relay device 620 exists according to an embodiment of the present invention.

When the relay device 620 exists, the channel selection method may include a link setting process and a channel scanning process among a source device 610, the relay device 620, and a destination device 630.

A relay communication where the relay device 620 is additionally provided may need to verify a channel bonding specification of each of the source device 610, the relay device 620, and the destination device 630, and may need to scan channels and determine a communication channel based on the channel bonding specification. Only when all of the source device 610, the relay device 620, and the destination device 630 include the channel bonding specification, may a bonding channel be selected as the communication channel. When any one of the above may not support channel boding, the bonding channel may not be selected as the communication channel.

A channel scanning request, a channel scanning response, a channel change request, and a channel change response of FIG. 6 may use the channel selection command frame of FIG. 5.

In the relay communication, each communication apparatus may perform channel scanning by considering the device combinations of the above Table 1 to transmit the channel selection command frame.

A relay command frame may be used for setting a detour path in the relay communication. The relay command frame may be classified into a “relay reservation request”, a “relay reservation response”, a “relay set request”, a “relay set response”, a “relay complete request”, a “relay complete response”, and the like, according to a relay command subtype field value.

In operation S601, the source device 610 may transmit a relay reservation request message to the relay device 620. In operation S603, the relay device 620 may transmit a relay reservation response message to the source device 610 in response to the relay reservation request message.

In operation S605, the source device 610 and the destination device 630 may perform antenna training.

In operation S607, as soon as antenna training with the relay device 620 is completed, the source device 610 may immediately transmit a channel scanning request to the destination device 630.

In operation S609, the source device 610 and the destination device 630 may perform channel scanning. In operation S611, when channel scanning is completed, the destination device 630 may transmit, to the source device 610, a channel scanning response that includes channel scanning information.

In operation S613, as soon as the source device 610 receives the channel scanning response from the destination device 630, the source device 610 may immediately transmit a relay set request to the relay device 620. In operation S615, the relay device 620 may transmit a relay set response to the source device 610 in response to the relay set request.

In operation S617, the source device 610 and the relay device 620 may perform antenna training.

In operation S619, when the source device 610 completes the antenna training with the relay device 620, the source device 610 may transmit a channel scanning request to the relay device 620.

In operation S621, the source device 610 and the relay device 620 may perform channel scanning. As described above, the source device 610 and the relay device 620 may be aware of a start or end time of channel scanning in advance based on scan timing information included in an information element field of the channel selection command frame.

In operation S623, when channel scanning is completed, the relay device 620 may transmit, to the source device 610, a channel scanning response that includes channel scanning information.

In operation S625, when the source device 610 receives the channel scanning response from the relay device 620, the source device 610 may transmit a relay complete request to the destination device 530.

In operation S627, when the destination device 630 receives the relay complete request, the destination device 630 may perform antenna training with the relay device 620. In operations S629 through 5633, the destination device 630 may perform a channel scanning process with the relay device 620.

In operation S635, when the channel scanning process with the relay device 620 is completed, the destination device 630 may transmit a relay complete response to the source device 610.

When the relay complete response is received from the destination device 630, the source device 610 may select a channel suitable for a communication with the relay device 620 and the destination device 630.

In operations S637 through S645, the source device 610, the relay device 620, and the destination device 630 may perform a channel change request, a channel change response, and channel switching.

As described above, in a relay communication according to an embodiment of the present invention, when an antenna training process between a source device and a destination device, between the source device and a relay device, and between the destination device and the relay device is completed, channel scanning may be immediately performed.

The exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of selecting a channel in a wireless system, the method comprising:
generating a channel scanning request frame that includes a channel bitmap, the channel bitmap denoting information regarding a channel to be scanned by a neighboring device;
transmitting the channel scanning request frame to the neighboring device;
receiving a channel scanning response frame corresponding to the channel scanning request frame; and
selecting a channel for a communication with the neighboring device, based on the channel scanning response frame.

2. The method of claim 1, wherein the channel bitmap includes the same number of bits as a number of channels available in a network.

3. The method of claim 1, wherein the channel bitmap corresponds to each of unit channels available in the network and a bonding channel of the unit channels.

4. The method of claim 1, wherein the generating comprises:
verifying specification information of the neighboring device;
verifying available channels of the neighboring device based on the specification information; and
determining the channel to be scanned by the neighboring device, among the available channels.

5. The method of claim 1, wherein the channel scanning response frame includes a number of information elements corresponding to a number of channels to be scanned by the neighboring device, and each of the information elements includes information associated with an available time slot in each of the channels scanned by the neighboring device.

6. The method of claim 1, wherein:
the channel scanning request frame includes a channel selection control field, and
the channel selection control field includes a command identification (ID) field to identify a type of a channel selection command frame, a reason code field to identify a reason of a channel change response result when the type of the channel selection command frame is a channel change response, and a channel bitmap field that includes the channel bitmap indicating the channel to be scanned by the neighboring device.

7. The method of claim 1, wherein the selecting comprises selecting the channel for the communication with the neighboring device based on scanning information associated with the channel scanned by the neighboring device and scanning information associated with a channel scanned by a communication apparatus receiving the channel scanning response frame.

8. An apparatus for selecting a channel in a wireless system, the apparatus comprising:
a channel scanning request frame generator to determine a channel to be scanned by a neighboring device among channels available in a network, and to generate a channel scanning request frame indicating the channel to be scanned by the neighboring device;
a transceiver to transmit the channel scanning request frame to the neighboring device, and to receive a response message with respect to the channel scanning request frame from the neighboring device;
a channel scanner to scan a channel excluding the channel to be scanned by the neighboring device among the available channels in the network; and
a channel selection/switching unit to select a channel for a communication with the neighboring device based on the response message, and to performing channel switching to the selected channel.

9. The apparatus of claim 8, wherein the channel scanning request frame includes a channel bitmap indicating the channel to be scanned by the neighboring device, and the channel bitmap includes the same number of bits as a number of the available channels in the network.

10. The apparatus of claim 9, wherein the channel bitmap corresponds to each of unit channels available in the network and a bonding channel of the unit channels.

11. The apparatus of claim 8, wherein the channel scanning request frame generator verifies specification information of the neighboring device, verifies available channels of the neighboring device based on the specification information, and determines the channel to be scanned by the neighboring device, among the available channels.

12. The apparatus of claim 8, wherein the channel scanning response frame includes a number of information elements corresponding to a number of channels to be scanned by the neighboring device, and each of the information elements includes information associated with an available time slot in each of the channels to be scanned by the neighboring device.

13. The apparatus of claim 8, wherein:
the channel scanning request frame includes a channel selection control field, and
the channel selection control field includes a command ID field to identify a type of a channel selection command frame, a reason code field to identify a reason of a channel change response result when the type of the channel selection command frame is a channel change response, and a channel bitmap field that includes the channel bitmap indicating the channel to be scanned by the neighboring device.

14. The apparatus of claim 8, wherein the channel selection/switching unit selects the channel for the communication with the neighboring device based on scanning information associated with the channel scanned by the neighboring device and scanning information associated with the channel scanned by the channel scanner.
